(19) United States
(12) Patent Application Publication
(10) Pub. No.: US 2005/0241447 A1
(43) Pub. Date: Nov. 3, 2005

(54) Tool for working wood or similar materials, and relative method to make the same

(75) Inventor: Sandro Marcuzzi, Udine (IT)

Correspondence Address: STEVENS DAVIS MILLER & MOSHER, LLP, 1615 L STREET, NW, SUITE 850, WASHINGTON, DC, 20036, US

(73) Assignee: POZZO SpA, Tavagnacco (IT)

(21) Appl. No.: 11/071,296

(22) Filed: Mar. 4, 2005

(30) Foreign Application Priority Data
Apr. 29, 2004 (IT) UD2004A000082

(51) Int. Cl. B27C 9/00; B27B 13/02

(52) U.S. Cl. 83/13; 83/835; 83/846; 83/676

(57) ABSTRACT

Tool for working wood or similar materials, and relative method to make the same. The tool comprises a substantially flat central body, made of a first metal material, and a plurality of cutting elements made of a second metal material. The plurality of cutting elements is disposed on the periphery of the central body and performs the working of the wood by removing woodchips therefrom. The tool also comprises a covering layer made of a third metal material, which has a higher level of hardness at least than that of the second metal material, and is disposed on the lateral surfaces of the central body or on the plurality of cutting elements, in order to increase the tribological properties thereof.

### FIELD OF THE INVENTION

The present invention concerns a tool, such as for example a circular blade, a saw or suchlike, to make mechanical workings on wood or similar materials, such as for example chipboard, MDF, plywood or suchlike. To be more exact, the tool according to the present invention comprises a covering layer, arranged to cover its outer surfaces, in order to limit wear and improve the conditions of the cutting elements.

### BACKGROUND OF THE INVENTION

Tools are known, such as for example circular blades, for cutting wood or similar materials, normally consisting of a flat steel body, shaped like a disk, which comprises a plurality of cutting elements, arranged in proximity with its circular outer surface, commonly called teeth. The latter are usually made of hard metal (HW) and are able to cut the wooden object by removing woodchip. Moreover, on the flat body there are normally seatings to discharge the chip and/or serpentine notches. The latter are able to absorb vibrations and to make the blade silent during use.

The teeth of conventional circular blades are normally attached to the flat body by means of a braze welding process, which consists in melting at relatively low temperatures, around 900° C., an alloy based on copper, silver, cadmium or otherwise, located between the flat body and the tooth itself.

During the usual technological cutting processes however, circular blades are subject to different types of wear, such as abrasive-type wear, due to the contact between the blade and the wood being worked, and also adhesive-type wear, due to the chemical-physical affinities between the blade and the wood being worked. They are also subject to damage, for example by splintering, when because of the wood that remains on the cutting edge of the teeth, small splinters of the latter are removed by tearing, or by cratering, due to the abrasive-adhesive phenomena on the breast of the blade, and others.

Such wear and damage, combined together, considerably reduce the life of the circular blade and also the quality of the cutting performed.

In the technology of constructing tools for working paper or metals, it is also known to cover externally one or more surfaces of the tool with a metal having a high level of hardness, by means of a process of chemical deposition in a vapor phase, in order to limit the wear, increase the duration and guarantee the sharpness over time of the teeth of said tools.

The known technique provides to use a heated chamber, or oven, into which the reagents in their vapor or gaseous state are introduced. Through chemical reactions of reduction or thermic decomposition, in the vapor phase, these provide to deposit covering layers on the outer surfaces of the tool, which acts as a catalyzer.

However, the heated chamber needs a working pressure of between about 10 and about 100 mbar, while the temperatures used during the process oscillate between about 800° C. and about 1100° C.

These working parameters actually cause several disadvantages, including a considerable reduction in resistance to transverse breakage of the tool.

Moreover, this known technique cannot be used to cover tools for working wood or similar materials which, as we have seen, comprise braze welded alloys connecting the teeth and the flat body. The latter, moreover, is normally made of steels which have tempering temperatures of around 300° C., so that, if the above chemical deposition process were used, the mechanical characteristics of the flat body, and hence those of the whole tool, would be worse.

One purpose of the present invention is to achieve a tool for working wood or similar materials, which has a high resistance to phenomena of wear to which it is subjected during the working steps, and which will maintain unchanged over time the quality and precision of the working performed, for example cutting.

Another purpose of the present invention is to perfect a method that allows to make a tool for working wood or similar materials resistant to phenomena of wear, without affecting the mechanical characteristics of the tool and of the materials of which it is made.

The present Applicant has devised, tested and embodied this invention to overcome the shortcomings of the state of the art and to obtain these and other purposes and advantages.

### SUMMARY OF THE INVENTION

The present invention is set forth and characterized in the main claims, while the dependent claims describe other characteristics of the invention or variants to the main inventive idea.

In accordance with the aforesaid purposes, a tool according to the present invention is applied for working wood or similar materials, and comprises a central body, substantially flat, made of a first metal material, and a plurality of cutting elements made of a second sintered composite material, arranged on the periphery of the central body, and able to work the wood by removing woodchips.

According to a characteristic feature of the present invention, the tool also comprises a covering layer, made of a third metal material, which has a level of hardness higher than that of the second metal material, and is arranged on the lateral surfaces of the central body and/or of the cutting elements, so as to increase the tribological properties of the tool. The tribological properties are resistance to cutting forces, ease of sliding of the woodchip and the tool itself inside the wood, resistance to abrasion, to corrosion, to fatigue and others.

In this way, it is possible to make the wood-working tool according to the invention more resistant to the phenomena of wear and damage to which it is subjected during the working steps.

With the present invention it is also possible to guarantee a greater duration in time of the quality and precision of the work performed, since the cutting elements are more protected from outside stresses.

In a preferential form of embodiment, the covering layer consists of nitrates, or carbon nitrates with titanium (TiN and TiCN), zirconium (ZrN), chromium (CrN) and titanium-aluminum (TiAlN and TiAlCN) and other combinations thereof. Advantageously, the covering layer has a thickness in the range of several micron (thousandths of a millimeter), for example varying from about 1 to about 5 μm, so as not to modify the characteristic dimensions of the tool, and hence allow to work with the usual standards.

According to the present invention, the method to make the aforesaid tool for working wood or similar materials comprises at least an assembly step wherein the cutting elements are arranged on the periphery of the central body, at least a loading step, after the assembly step, wherein the wood-working tool is positioned inside an environment with controlled pressure and temperature, and at least a vaporization step, wherein a third metal material is vaporized inside the environment with controlled pressure and temperature, in order to deposit a covering layer formed by said third metallic material on the outer surfaces of the wood-working tool.

In a preferential embodiment of the present invention, during the vaporization step, the working temperature is less than the tempering temperature of the first material; the working temperature is less than about 300° C.

The materials can be vaporized using various known techniques, according to the properties that are to be conferred on the covering layer, provided that they include a maximum temperature of use that is lower than the tempering temperature of the second metallic material. To give an example, not restrictive, the vaporization can occur by means of evaporation with electronic band, magnetron pulverization, arc evaporation, whether this be with a hollow cathode, low voltage or under vacuum, or using other techniques of a substantially conventional type.

With the method according to the present invention it is therefore possible to deposit on all the outer surfaces of the woodworking tool a covering layer without affecting the characteristics of the material that makes up the cutting elements, so as to make the woodworking tool resistant to phenomena of wear and to normal damage.

### BRIEF DESCRIPTION OF THE DRAWINGS

These and other characteristics of the present invention will become apparent from the following description of a preferential form of embodiment, given as a non-restrictive example with reference to the attached drawings wherein:

FIG. 1 is a partly sectioned side view of a tool for working wood according to the present invention;

FIG. 2 shows a sectioned and enlarged detail of the tool in FIG. 1;

FIG. 3 is a block diagram of some steps of the method to make the tool in FIG. 1.

### DETAILED DESCRIPTION OF A PREFERENTIAL FORM OF EMBODIMENT

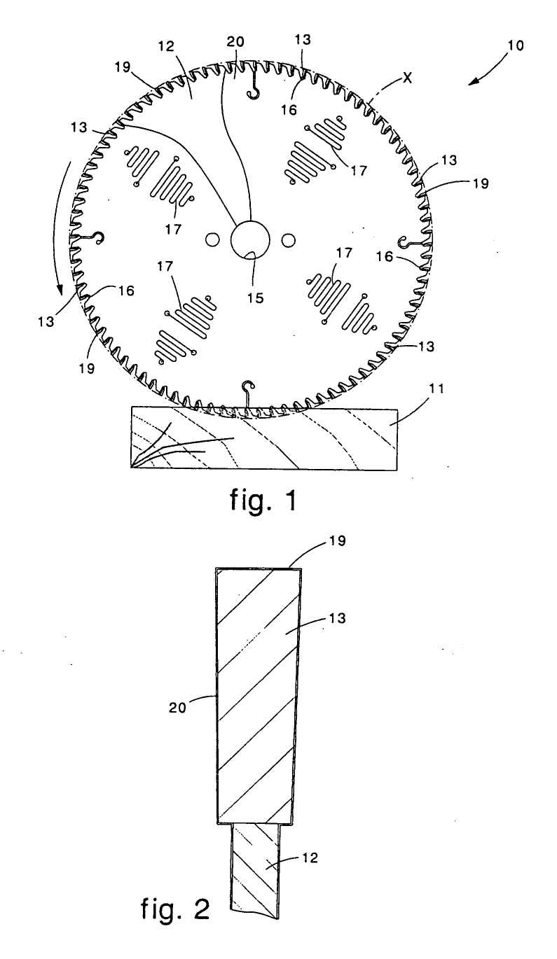

With reference to FIG. 1, a tool 10 for working wood or similar materials according to the present invention is in this case a circular blade able to cut a wooden object 11, and comprises a substantially disk-shaped flat body 12, and a plurality of cutting platelets 13, arranged on the periphery of the flat body 12 and able to cut the wooden object 11 when the flat body 12 is made to rotate with a determinate cutting speed.

The flat body 12 is made of steel and comprises an axial hole 15 to allow the tool 10 to be associated with a mandrel, of a conventional type and not shown in the drawings; a plurality of compartments 16, advantageously made near the respective cutting platelets 13, to facilitate the discharge of the wood chip; and a plurality of notches 17, substantially serpentine, and able to absorb the possible vibrations that are generated during normal cutting operations, and hence render the cutting more accurate and silent.

Each cutting platelet 13 is made of sintered material (HW) and comprises a cutting edge 19 having a determinate cutting angle, facing towards the outside and lying on a circular axis X defining the cutting diameter of the tool 10.

The cutting platelets 13 made of sintered material (HW) consist of compound hard metals wherein the particles of carbons are cemented with a ductile metal by means of a sintering process.

The reciprocal connection between the cutting platelets 13 and the flat body 12 is achieved by means of a normal braze welding process, wherein an alloy based on copper, cadmium or other, positioned between the two, is melted at a temperature of around 900° C.

The cutting tool 10 according to the invention also comprises a covering layer 20 (FIGS. 1 and 2) made of a determinate covering metal material, which has a high level of hardness, and an optimum sliding coefficient.

The metal material can consist of powders composed of nitrates and/or carbonitrates alloyed for example with titanium (TiN and TiCN), zirconium (ZrN), chromium (CrN), titanium-aluminum (TiAlN and TiAlCN) or others, deposited on the outer surfaces of the cutting tool 10.

The covering layer 20 thus formed has characteristics of toughness, to prevent the risk of breakage, good surface hardness and optimum resistance to the high processing temperatures, so as not to suffer variations in size or lose its mechanical characteristics during the cutting steps.

Moreover, the covering layer 20 has a thickness variable from 1 to 5 μm and confers on the entire tool 10 an optimum resistance to wear, also when the latter is used in conditions which are far from optimum, and guarantees a longer duration of the sharpness of the cutting edge 19, and the finished quality of the cutting performed.

To be more exact, the covering layer 20 confers on the tool 10 an increase in its tribological properties with respect to traditional tools for wood, that is, a greater resistance to the cutting forces and a greater ease of the tool 10 itself to slide inside the wooden object 11.

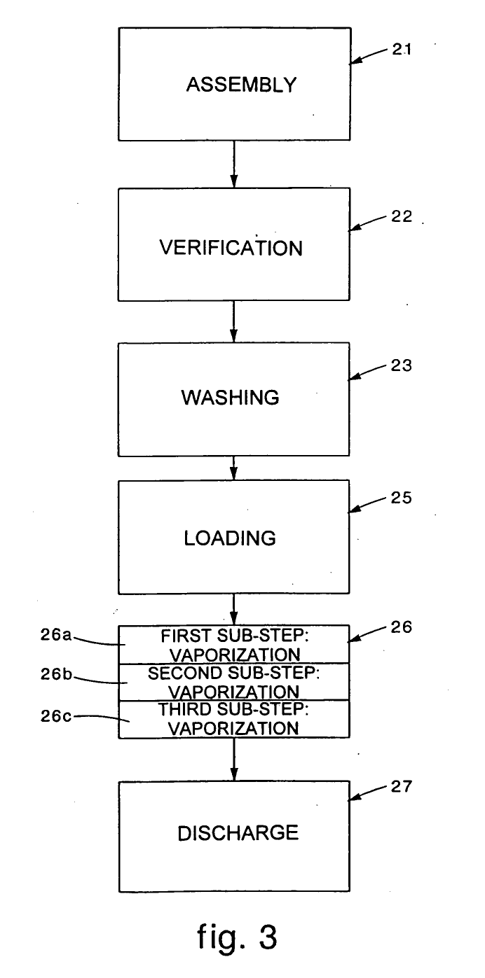

As shown schematically in FIG. 3, the method to make the tool 10 according to the present invention comprises an assembly step 21, a verification step 22, a washing step 23, a loading step 25, a vaporization step 26 and a discharge step 27 to discharge the tools 10 treated.

The assembly step 21 provides to assemble the cutting platelets 13 on the flat body 12 by means of braze welding.

The verification step 22 provides a quality control of the tools 10 assembled in the assembly step 21, to check whether they have dead holes or other details that are difficult to clean or defects of different nature not acceptable in the application of this technology.

The washing step 23 provides that the tools 10 are subject sequentially to: immersion in a bath of water and washing with detergents and ultrasounds; immersion in an electrolytic bath; rinsing; another immersion in water, to facilitate the discharge in osmosis of the demineralized water; shower wash; and placement in an oven under vacuum at about 105° C. in order to dry them.

In the event that one of the tools 10 washed should come into contact with impurities, it must again be subjected to the washing step 23.

The verification step 22 and the washing step 23 allow to prevent rust, dirt or decarburization on the surfaces to be covered, so as to ensure an optimum cover of the surfaces.

During the loading step 25, the washed tools 10 are loaded inside a chamber of a vaporization oven using a relative tool-bearing support, which allows to arrange the tools 10 so as to have a uniform height on the same plane and a symmetrical arrangement in shape and in mass. Therefore, the tools 10 with a greater cutting diameter are arranged at the center of the chamber of the oven. Inside the chamber of the oven a high vacuum is created, that is, the inner pressure is taken to about 10⁻⁵ mbar.

The vaporization step 26 substantially comprises a first sub-step 26a to transform the metal material to be deposited into the gaseous state; a second sub-step 26b to transport the metal material to be deposited, transformed into ionized gas, inside the vaporization oven; and a third sub-step 26c to condense the metal material to be deposited on the tool 10, in order to form the covering layer 20.

During the first sub-step 26a, the metal material to be deposited, for example titanium, is made to evaporate by exploiting the effect of an electric arc under vacuum. The source of the electric arc can consist, according to a substantially known technique, of one or more metal plates, rectangular or circular, located at a negative potential, for example with a cathode connection with a voltage of between about −15V and about −30V, arranged at the sides of the chamber of the deposition oven.

The electric arc generated thus causes a quantity of gross metal to evaporate, proportional to the intensity of its current, and is accelerated and guided along a desired trajectory, by means of a magnetic field, during the second sub-step 26b, towards the tools 10 to be covered, located at a negative potential, for example with a transverse tension variable from between a few dozen volts to about −1200V.

The evaporated metal material reacts with a reactive gas introduced, such as for example N₂, C₂H₂, CH₄, or others.

The heat load that develops in this step on the ends, and particularly on the tips of the tools 10, normally remains below about 300° C., that is, below the tempering temperature of the material that makes up the flat body 12.

Moreover, in the third sub-step 26c, wherein the vaporized metal material is deposited on the outer surfaces of the tool 10, the latter is moved for the whole duration of the process with respect to the source of the metal material to be deposited, in order to obtain substantially uniform thicknesses of the covering layer 20 deposited, whatever the geometric shape of the tool 10.

Advantageously, the Applicant has found that to obtain covering layers 20 with low inner tensions it is necessary to reduce the tensions in the interface between the covering 20 and the outer surface of the tool 10, by means of adequate transition layers, and this is achieved by optimizing the deposition parameters.

The discharge step 27 provides to remove the tools 10 from the vaporization oven in order to store them or subject them to possible further working and finishing steps.

It is clear, however, that modifications and/or additions of parts or steps may be made to the tool 10 and the relative production method as described heretofore, without departing from the field and scope of the present invention.

It is also clear that, although the present invention has been described with reference to specific examples, a person of skill in the art shall certainly be able to achieve many other equivalent forms of tool for working wood or similar materials, and relative production method, having the characteristics expressed in the claims and hence all of which shall come within the field of protection defined thereby.

1. A tool for working wood or similar materials, comprising a substantially flat central body of a substantially cylindrical form, made of a first metal material and provided with two lateral surfaces, and a plurality of cutting elements made of a second metal material, different from said first metal material, wherein said plurality of cutting elements is disposed on the periphery of said central body and is able to perform the working of said wood by removing woodchips therefrom, wherein a covering layer is made of a third metal material different from said first and second metal materials and has a higher level of hardness at least than that of said second metal material, and wherein said third metal material is disposed at least on said two lateral surfaces of said central body or on said plurality of cutting elements, in order to increase the tribological properties thereof.

2. A tool as in claim 1, wherein said covering layer consists of nitrates or carbonitrates alloyed with titanium, zirconium, chromium and titanium-aluminum, or of a chemical combination thereof.

3. A tool as in claim 1, wherein said covering layer has a thickness in the range of some microns.

4. A tool as in claim 1, wherein said first metal material is steel and wherein said central body comprises an axial through hole able to allow the connection thereof with driving means, a plurality of compartments able to facilitate the discharge of said woodchips, and a plurality of notches able to absorb any possible vibrations that are generated during the normal cutting operations.

5. A tool as in claim 4, wherein each of said cutting elements comprises a platelet which is made of sintered material with a high level of hardness, is attached to said central body near a compartment and is provided with a cutting edge having a determinate cutting angle.

6. A tool as in claim 5, wherein said sintered material is sintered in powder (HW).

7. A tool as in claim 5, wherein said platelet is attached to said central body by means of braze welding.

8. A method to make a tool for working wood or similar materials, provided with a substantially flat central body made of a first metal material, and a plurality of cutting elements made of a second metal material different from said first metal material and disposed on the periphery of said central body, wherein said plurality of cutting elements is able to perform the working of said wood by removing woodchips therefrom, said method comprising at least an assembly step, wherein said cutting elements are disposed on the periphery of said central body, at least a loading step, subsequent to said assembly step, wherein said tool for working wood or similar materials is positioned inside an environment with controlled pressure and temperature, and at least a vaporization step, wherein a third metal material, different from said first and second metal materials, is vaporized inside said environment with controlled pressure and temperature, in order to deposit a covering layer of said third metal material at least onto the lateral surfaces of said central body or of said cutting elements.

9. A method as in claim 8, wherein, during said vaporization step, the working temperature is lower than the tempering temperature of said first metal material.

10. A method as in claim 8, wherein in said assembly step said cutting elements are attached to said central body by means of braze welding.

11. A method as in claim 8, wherein between said assembly step and said loading step there is at least a washing step, wherein said tool for working wood or similar materials is sequentially immersed in a water bath and washed with detergents and ultrasounds, then immersed in an electrolytic bath, then rinsed and then again immersed in water, in order to facilitate the discharge in osmosis of the demineralized water, then shower washed, and finally arranged in an oven in order to dry said tool.

12. A method as in claim 11, wherein between said assembly step and said washing step at least a verification step is provided, wherein a quality control is carried out of said tool assembled during said assembly step.

13. A method as in claim 8, wherein in said loading step a plurality of tools is loaded inside said environment with controlled pressure and temperature by means of a relative tool-bearing support, so that any of said tools is arranged with respect one to the other at a uniform height on a same plane, and symmetrically.

14. A method as in claim 8, wherein said vaporization step comprises a first sub-step wherein said third metal material is transformed into a gaseous state; a second sub-step wherein said third metal material transformed into gas is transported along a desired trajectory inside said environment with controlled pressure and temperature; and a third sub-step to condense said third metal material on said tool in order to form said covering layer.

15. A method as in claim 14, wherein in said first sub-step said third metal material is made to evaporate by exploiting the effect of an electric arc in a vacuum.

16. A method as in claim 14, wherein in said second sub-step said third metal material transformed into gas is accelerated and guided along a desired trajectory, by means of a magnetic field.

17. A method as in claim 14, wherein in said third sub-step said tool is moved with respect to the source of said third metal material so as to have a substantially uniform thickness of said covering layer.

18. A method as in claim 8, wherein subsequent to said vaporization step a discharge step is provided, wherein said tool is discharged from said environment with controlled pressure and temperature.
